(19) United States
(12) Patent Application Publication
(10) Pub. No.: US 2026/0300467 A1
(43) Pub. Date: Oct. 1, 2026

(54) SYSTEMS AND METHODS FOR CONFIGURATION OF EXECUTION OF AUTHORIZATION PROCESSES FOR ACCESS TO A DISTRIBUTED SERVICE SYSTEM

(71) Applicant: Stripe, Inc., South San Francisco, CA (US)

(72) Inventors: Anthony Pianta, Washington, DC (US); Manav Khandelwal, New York, NY (US); Bradley Ramunas, Seattle, WA (US)

(21) Appl. No.: 19/095,374

(22) Filed: Mar. 31, 2025

(51) Int. Cl. G06F 21/44; G06F 21/62

(52) U.S. Cl. CPC G06F 21/44; G06F 21/6218

(57) ABSTRACT

A method and apparatus for authorization of a distributed service request by a first server computer system are described. The method includes the first server computer system receiving, from a third server computer system, a service request to access a distributed service. An authorization configuration defined by a second server computer system is fetched, where the authorization configuration is associated with the third server computer system, and defines one or more attributes for conditional application of an authorization process for determining access to the distributed service by the third server computer system. The authorization process configured based on the one or more attributes to authorize the third server computer system is performed, and An authorization result is generated in response to performing the authorization process configured based on the one or more attributes.

### BACKGROUND

Server computer systems provide remote services to client systems over a network, such as the internet, a local network, a telecommunications network, or a combination of various network types that enable communication between remotely located systems. The services can include, for example, storing and/or transferring data, fraud detection, performing an action requested by a first computing system with another remotely located computing system, as well as a number of other services that may be remotely provided by the server computer systems. Such server computer systems typically offer multiple services for the clients of the server computer system, where execution of the services is distributed among processing resources of the server computer system.

In some scenarios, server computer systems enable a first client system to offer the services of the server computer system to a second client system. This can be referred to as a software as a service that the first client system offers to the second client system. Then, once a relationship between the second client system and the server computer system is established via the first client system, service requests from the second client system may be made directly from the second client system to the server computer system. However, the first client system maintains responsibility for the second client system's usage of the server computer system, and thus improper use of services by the second client system at the server computer system may be attributed by the server computer system back to the first client system as well as the second client system.

A technical problem therefore arises in that the second client system can make service requests for one or more distributed services offered directly to the server computer system. While the server computer system may exert some controls over access to and execution of the services, the relationship of the first client system to the server computer system and to the second client system should enable the first client system to have some authority over those controls. However, providing a client system control over another client system that directly requests services of the server computer system is a new application scenario for the server computer system offering their services to client systems. Thus, improved techniques for authorization of client system service requests that reflect the above described application scenario is a technical challenged that needs to be addressed.

Furthermore, the distributed nature of the server computer system enables the server computer system the capability to offer its services to client systems in different real world locations. When the client system and physical resources of the server computer system are not collocated in a geographic region, this may introduce inefficiencies in the access to, and authorization of, service requests when, for example, a physical hardware resource of the server computer system is located in a first geographic location, and a client issues a service request from a second geographic location. Therefore, how to more efficiently authorize and provide distributed services to client system is also a technical challenge that needs to be addressed.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of an exemplary system architecture for a server computer system that enables a platform client system to configure authorization and access of connected client systems to distributed service systems of the server computer system.

FIG. 2 is a block diagram of one embodiment of a service request authorization system.

FIG. 3 is a block diagram of an embodiment of location based authorization configuration fetching performed by a service request authorization system.

FIG. 4 is a block diagram of one embodiment of performing configuration of service request authorization.

FIG. 5 is a flow diagram of one embodiment of a method for performing service request authorization.

FIG. 6 is a flow diagram of another embodiment of a method for providing an analytics interface for analysis of configured authorization performance.

FIG. 7 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “generating”, “serving”, “receiving”, “storing”, “replicating”, “fetching”, “determining”, “performing”, “blocking”, “aggregating”, “querying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

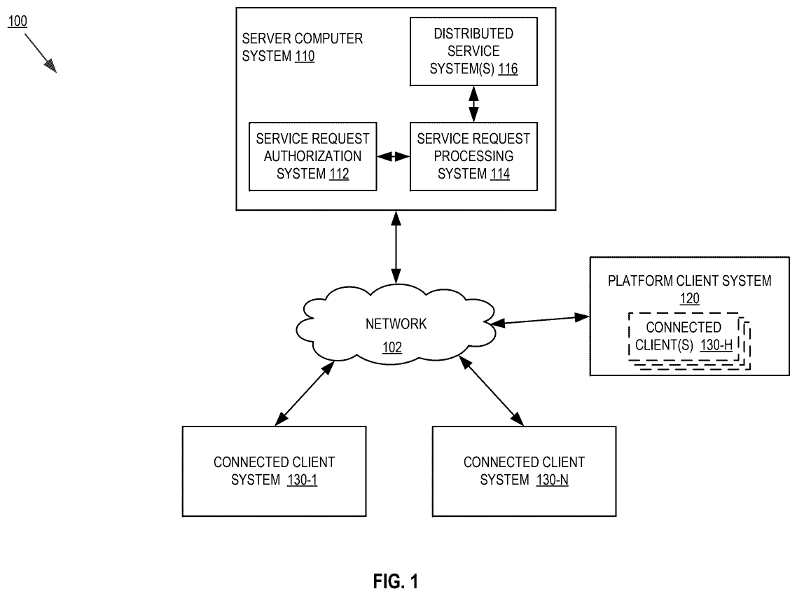

FIG. 1 is a block diagram of an exemplary system architecture 100 for a server computer system 110 that enables a platform client system 120 to configure authorization and access of connected client systems, such as connected client systems 130-1 through 130-N, to distributed service systems of the server computer system 110.

In one embodiment, the system 100 includes server computer system 110, a platform client system 120, and a plurality of connected client systems (e.g., client system 130-1 through client system 130-N, sometimes referred to herein as connected client system 130 or connected client systems 130). In one embodiment, one or more systems (e.g., systems 120 and/or 130) may be mobile computing devices, such as a smartphone, tablet computer, smartwatch, etc., as well computer systems, such as a desktop computer system, laptop computer system, server computer systems, etc. The server computer system 110, platform client system 120, and connected client system 130 may also be one or more computing devices, such as one or more server computer systems, desktop computer systems, etc. Furthermore, there may be any number of platform client systems and connected client systems utilizing the distributed service system(s) 116 of the server computer system 110, consistent with the discussion herein.

Furthermore, it should be appreciated that the embodiments discussed herein may be utilized by a plurality of different types of server computer systems. For example, server computer system 110 can provide distributed services that perform data storage and distribution services, multimedia access services, gaming services, real time image and video systems, transaction authorization systems, as well as other types of systems in which authorization of services requested to be performed at the server computer system 110 by the connected client systems 130 is performed.

The server computer system 110, platform client system 120, and connected client systems 130 may be coupled to a network 102 and communicate with one another using any of the standard protocols for the exchange of information, including secure communication protocols. In one embodiment, one or more of the server computer system 110, platform client system 120, and connected client systems 130 may run on one Local Area Network (LAN) and may be incorporated into the same physical or logical system, or different physical or logical systems. Alternatively, the server computer system 110, platform client system 120, and connected client systems 130 may reside on different LANs, wide area networks, cellular telephone networks, etc. that may be coupled together via the Internet but separated by firewalls, routers, and/or other network devices. In one embodiment, server computer system 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In embodiments discussed herein, server computer system 110 provides services via network 102. The services are provided by a set of distributed service systems 116, which are computationally distributed and/or physically distributed between different hardware systems of the server computer system 110. The services can include, for example, onboarding services to collect information from a new client system, data distribution services for storing, moving, consolidating, etc. client system data, facilitating interactions between a client system (e.g., platform client system 120 and/or connected client system 130) and a user of the client system, planning systems that enable server computer system 110 to provide planning of resources used by platform client system 120 and/or connected client system 130, etc., as well as a combination of such services that can be provided remotely over network 102. The services are often referred to as software as a service, as the software executed on server computer system 110 to perform an associated function is accessed as a service offered by server computer system 110 to remote client systems.

In some embodiments, platform client system 120 is a second server computer system that is onboarded to and has an account with the server computer system 110. The account establishment with server computer system 110 typically involves platform client system 120 providing identification information, and proof of such information, to enable server computer system 110 to determine that the platform client system 120 is legitimate. Furthermore, platform client system 120 is referred to as a platform client system because platform client system 120 will onboard and enable account establishment of connected client systems 130-1 through 130-N at server computer system 110, and in some embodiments will host connected client(s) 130-H to access services of the server computer system 110 from the platform client system 120. Each connected client system 130 will also typically provide identification information, and proof of such information, to enable server computer system 110 to determine that the connected client system 130 is also legitimate. Once a connected client system 130 has established an account, the connected client system 130 may directly access a distributed service of the server computer system 110, either from a connected client system (e.g., connected client system 130-N) or from a connected client hosted on resources (e.g., connected client 130-H). In embodiments, connected client systems, such as connected client system 130-N accesses services and communicates directly with the server computer system 110 using a set of application programming interface(s) (APIs), software development kit(s) (SDKs), or a combination thereof distributed by server computer system 110 and/or platform client system 120. In embodiments, connected client(s) 130-H, are hosted services, such as web pages, applications, etc. in which the platform client system 120 uses the APIs, SDKs, or a combination on behalf of the connected client(s) 130-H to communicate with server computer system 110. As discussed herein, references to connected clients 130 or connected client systems 130 are used interchangeably to refer to either embodiment of a connected client system 130-1 through 130-N and/or hosted connected client(s) 130-H.

In either embodiment, the platform client system 120 and the connected client system 130 therefore have a relationship between each other, as well as a relationship to the server computer system 110. More specifically, and as discussed in greater detail herein, if a connected client system (e.g., connected client system 130-N or 130-H) is fraudulent or attempts to make service requests for fraudulent or nefarious purposes, not only is the connected client system held accountable (e.g., blocked or barred from accessing the distributed service system(s) 116, and in some instances blocked or barred from all access to the server computer system 110), but the platform client system 120 that onboarded the connected client system to the server computer system 110, an in some embodiments hosts connected client(s) 130-H, may also suffer repercussions, such as blocking the platform client system 120 from onboarding of new connected client systems 130, setting more stringent onboarding standards, and in some instances proactively blocking the platform client system 120 and/or associated connected client systems 130-N and/or 130-H (that have not yet been detected as perpetrating fraud on the server computer system 110) from accessing the distributed service system(s) 116. Therefore, the platform client system 120 will want to exert control over detection of both whether a connected client 130 is itself fraudulent, as well as whether a service request initiated by the connected client system 130 (e.g., by the connected client system or a user of the connected client system) is fraudulent. In embodiments, and as will be discussed in greater detail herein, platform client system 120 can configure and implement service request authorization applied to individual connected client systems 130, can configure and implement service request authorization applied to groups of connected client systems 130, can override service request authorization configurations created by connected client systems 130, and/or can combine service request authorization configurations created by the platform client system 120 with those created by a connected client system 130.

In embodiments, service request processing system 114 of the server computer system 110 receives service requests from a connected client (e.g., connected client system 130-N or 130-H). As discussed herein, those service requests include access to and use of the distributed service system(s) 116 of the server computer system. However, before providing access to and execution of a requested service, service request authorization system 112 is responsible for authorizing the connected client system (e.g., authorizing the connected client system is legitimate and was not established by fraud or has not been taken over by a fraudster) and/or authorizing the service system request (e.g., authorizing parameters of the requests, authorizing access to a service, etc. to detect whether this instance of a service request is fraudulent). Service request authorization system 112 can include one or more heuristic fraud detection systems, one or more trained machine learning model fraud detection systems, as well as other fraud detection systems that can be configured to detect whether a connected client system 130 or a service request initiated by the connected client system 130 is fraudulent.

In embodiments, as discussed herein, to authorize a connected client system 130 and/or a service request initiated by the connected client system 130, service request authorization system 112 accesses one or more authorization configurations generated by the connected client system 130 and one or more authorization configurations generated by the platform system 120. While the platform client system 120 is not responsible for initiating the current service request, the platform client system 120 does have responsibility and potential liability for fraud committed by the connected client system 130 as the system that caused the connected client system 130 to be onboarded to the server computer system 110. Therefore, in embodiments, service request authorization system 112 enables platform client system 120 to generate authorization configurations, also referred to herein as rules or authorization rules, that can conditionally be applied to connected client system 130 service requests.

In embodiments, in an authorization configuration phase, platform client system 120 and/or a connected client system 130 generate authorization configurations that control fraud detection performed by service request authorization system in response to service requests. Such authorization configurations or rules are formed by selection of which fraud detection systems to apply (e.g., which models, heuristics, etc. to apply), and how those fraud detection systems are configured at run time (e.g., what threshold values are used to compare against fraud predictions, what values are used for heuristic determinations, etc.).

For example, a heuristic fraud detection system that utilizes blocking counts can be configured so that if a number of blocked service requests exist for a client system over a specified time period satisfies a threshold value, a current service request should be blocked. As another example, a threshold for a service request machine learning fraud detection system that takes as input a IP address of a connected client system, service request parameters, count values (e.g., number of blocked service requests over a time period, a count or rate of initiated service requests, etc.) can be configured to determine how a score generated by the machine learning model is interpreted for a service request. Therefore, authorization configurations defined by the platform client system 120 can establish connected client-level controls (e.g., risk that a connected client is fraudulent >x based on a heuristic or machine learning model based fraud detection system, block connected client from access to and use of the distributed service system(s) 116), service request-level controls (e.g., risk that a service request is fraudulent >y, block the service request), or combined based on both connected client-level and service request-level risks (e.g., risk_{connected_client_ID}>x or risk_{service_request_ID}>y, block a the service request).

In some embodiments, platform client system 120 may further specify application parameters for connected client-level and service request-level rules. The application parameters can include identification of specific connected client systems to which specific rule configurations are to be applied (e.g., client system 130-1 is associated with rule configurationᵢ, client system 130-N is associated with rule configurationⱼ, connected client 130-H is associated with rule configurationₕ, each connected client systems 130-1, 130-N, and 130-H are associated with rule configurationₖ, and all connected client systems 130 associated with platform system 120 are associated with rule configuration_{L}). Furthermore, the application parameters can further specify whether connected client system 130 rules are blocked, combined with, or run in parallel with the platform client system rules. Therefore, the rule configurations and the application parameters enable platform client system 120 great flexibility for configuration of authorization of its associated connected client systems 130.

Furthermore, in embodiments, each connected client system 130 may also generate rules for detection of whether service requests initiated by or through the connected client system 130 are fraudulent. In embodiments, the connected client system 130 generated rules include service request-level controls, as client systems 130 do not establish rules or authorization configurations challenging their own validity.

In embodiments, when a service request is received by the service request processing system 114, such a service request will typically pass request parameters (e.g., a type of service requested, amounts associated with the service, a time for service request processing, etc.), one or more identifiers (e.g., a connected client system identifier, an IP address of a request system, in some embodiments a platform client system identifier, an account identifier, as well as other identification data), authorization credentials, etc. Service request authorization system 112 will then fetch the authorization configurations/rules from a storage that are associated with (e.g., generated by) the identified connected client system 130, as well as the platform client system 120 associated with the connected client system 130. As discussed herein, service request authorization system 112 is capable of executing a plurality of different types of service request authorizations, and the fetched authorization configurations identify which authorizations to perform, what modes of authorization are to be performed (e.g., service request-level authorization, connected client-level, or a combination), how authorization is configured (e.g., what thresholds are applied to which authorization processes), whether platform client system 120 rules supersede or are combined with connected client system rules, etc. The authorization configurations and application parameters are then used by service request authorization system 112 to configure and execute one or more authorization processes against the service request in real time or near real time as the service request is received.

When service request authorization system 112 determines that the authorization process(es) are completed successfully, the connected client service request can be passed to the distributed service system(s) 116 for processing of the requested service. However, when the service request authorization system 112 determines that the authorization process(es) should be blocked (e.g., fail at least one authorization process), the service request and/or connected client system are blocked. The service request authorization system 112 stores data, such as the authorization processes performed, the configuration values, the application configurations, etc. in a data store for later analysis and authorization configuration refinement.

In embodiments, the platform client system 120 defined authorization configurations and application parameters enables the platform client system 120 to not only establish what authorization processes to apply to connected client systems (e.g., platform client generated and/or connected client system generated), but also how those processes should be configured. For example, risk levels generated by a heuristic model, fraud model, machine learning model, etc. for a connected client can trigger application of more stringent authorizations (e.g., rule 1: connected client fraud risk>x and fraud machine learning model score >0.7==block; and rule 2: connected client fraud risk<=x and fraud machine learning model score>0.9==block). As another example, authorization configurations can be set to apply globally to all connected client systems associated with a platform system, to individual connected client systems (e.g., based on ID), to a set of client systems based on a set of identification values, to client systems have a predefined trait (e.g., connected client system age<x; connected client system IP address within regions A, B, and C; etc.). As yet another example, the conditional application of certain rules discussed above can further be combined with fetched connected client system rules. Therefore, the platform client system 120 is given great flexibility to control how the connected client systems 130, for which platform system 120 was responsible for onboarding to the server computer system 110, and the connected client systems'130 service requests are authorized by the server computer system.

Furthermore, authorization configurations include new configuration features (e.g., connected client risk levels, identification of specific connected clients, conditional application of rules to connected client's based on risk level, combination of platform rules with connected client rules, etc.) that account for the relationship of the platform client system 120 with the connected client systems 130, which establishes liability for actions of the connected client systems 130 for fraud committed on the service computer system 110. Inclusion of these features, which can be defined by a platform client system and used against direct service requests of the connected client systems improve access controls to the server computer system. Furthermore, the new controls enable more robust fraud detection to reduce incidences of fraud on the server computer system, thereby improving the operations of the server computer system.

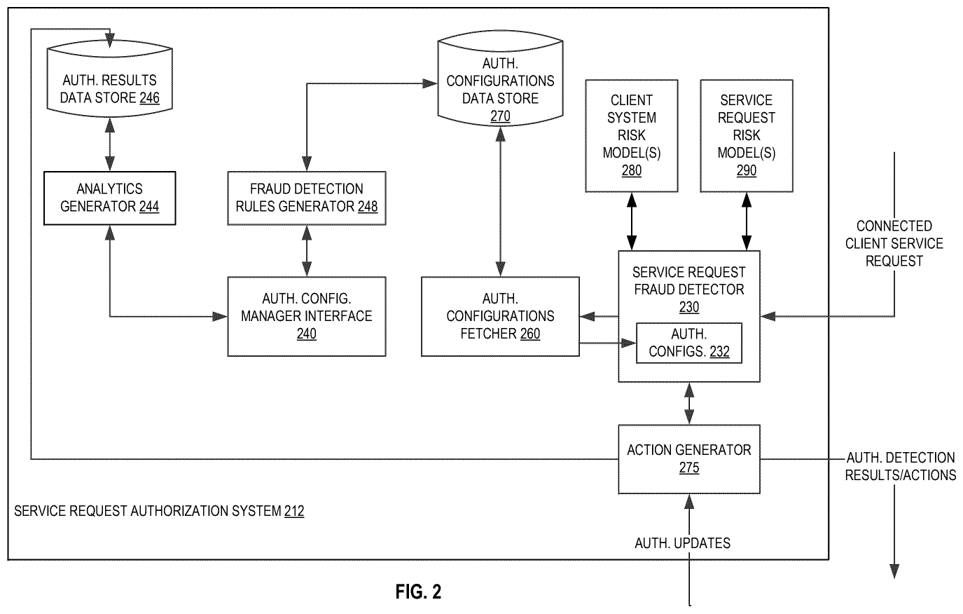

FIG. 2 is a block diagram of one embodiment of a service request authorization system 212. The service request authorization system 212 provides additional details for the service request processing system 112 discussed above in FIG. 1. Furthermore, service request authorization system 212 is comprised in a server computer system, such as server computer system 110. The server computer system may be a single computer server system, a plurality of interconnected server systems, and/or remotely located server computer systems communicatively coupled via a network (e.g., network 102). In some embodiments, service request authorization system 212 may therefore be an instance of a service request authorization system, with instances distributed and executed at different server computer systems responsive to load, geographic limitations, compute power available at specific server systems, etc.

Authorization configuration interface 240 of the service request authorization system 212 is responsible for generating a user interface (e.g., a dashboard, web page, etc.) served to a platform client system or a connected client system (not shown). The user interface is an interface for receipt of authorization configuration definitions or parameters used by fraud detection rules generator 248 for generating authorization configurations/rules and/or editing existing authorization configurations/rules. For example, a platform client system can define rules based on attributes defining how an authorization configuration should be applied, such as based on Platform_ID (e.g., an associated authorization configuration is globally applicable to all connected client systems associated with the platform client system), connected_client_ID (e.g., an associated authorization configuration is applicable to the identified connected client system), connected_client_type (e.g., hosted or not hosted), connected_client_age (e.g., brand new connected clients time<Y_days, total_#_service_requests<X, apply stricter rules or thresholds), connected_client_risk_score (e.g., a MLM or fraud model analysis generating a risk score based on connected client attributes, such as IP address, fraud counts, request parameters, etc. where risk score>Z, apply a stricter rule or block a service request), counter based attributes (e.g., set threshold based on counter values number of disputes in last 30 days, number of blocked requests in the last 24 hours, etc. to apply a stricter rule or block a service request).

As discussed herein, many of these attributes provide new forms of determining which authorization configurations to apply and how to apply them, which is based on the relationship between the platform client system and the connected client systems. That is, during a service request, a platform client system may want to have authorization configurations based on connected client-level fraud detections and/or service request-level fraud detection. Furthermore, the rules definitions or parameters used by fraud detection rules generator 248 can further include an identification of the fraud models, heuristics, machine learning models, etc. that are to be used for execution of a configured authorization process. Thus, platform client system can define, configure and cause to be executed authorizations in different modes (e.g., at a connected client system-level, at a service request-level, a combination of levels, as well as in combination with connected client system defined authorization configurations), and with different parameters for each mode and/or service request, as discussed herein.

In embodiments, connected client systems may further define and generate authorization configurations. However, as discussed herein, the configurations are at a service request-level and apply globally to service requests initiated by the connected client system. Such connected client system authorization configurations can include selecting which authorization processes to use (e.g., fraud model, machine learning model, heuristic, etc. fraud detection, or a combination of processes), and configurations of how the selected processes are applied (e.g., selection of one or more thresholds to be used by each model to detect fraud in a service request).

Fraud detection rules generator 248 then stores the generated rules, their configurations, and associated identification data associated with the authorization configuration creator (platform_client_ID or connected_client_ID). In some embodiments, a rule and associated configured values and/or thresholds within the rule, may be written as a machine interpretable statement, with pseudocode for such as:

Rule_i:
platform_ID;
connected_clietn_ID;
Rule_Body: if MLM_risk>x and client_age<y, then
block_service_request.
   Other examples of rule statements that can be included and/or combined with other rule statements in a rule body, in embodiments, include: (a) “Request 3DS if: account: in @platform_identified_risky_accounts and :risk_score: >50” that initiates a secure authentication protocol, such as 3D Secure (3DS), if a connected client account is flagged as risky and a current authorization risk score is greater than 50; (b) “Block if: days_since_account_was_created: <30 and :auth_country: !=:acct_address_country:” that will block a requested service request authorization when a requesting connected client's account's age is below a threshold number of day and authorization information supplied to authorize a current service request does not match information in an established account for the connected client; (c) “Review if :total_account_transactions:<10” that initiates a manual review of a service request for a connected client that is determined to have generated a total number of service requests below a configured threshold; and (d) “Allow if: account: in @trusted_connected_accounts and: risk_score: <20” that allows a service request by a connected client if their account is part of a set of trusted or whitelisted connected client accounts and a risk score generated for a current service request satisfies a configured threshold value. The authorization configurations, once configured and generated, are stored in authorization configurations data store 270.

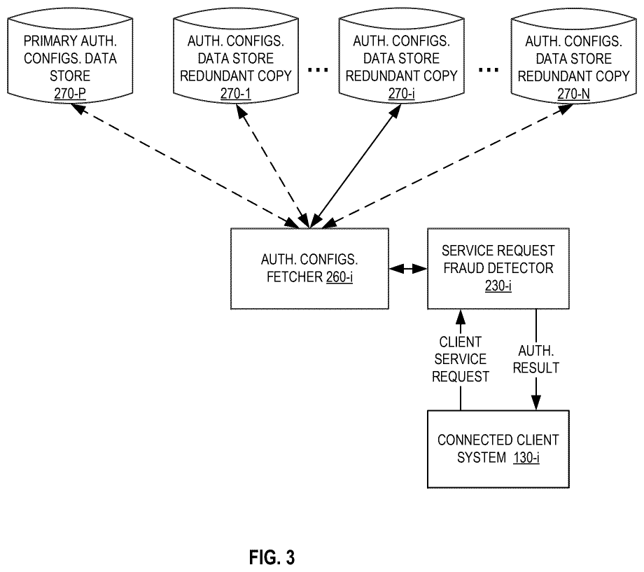

In some embodiments, fraud detection rules generator 248 may distribute authorization configurations to a number of redundant copies of the data store 270. For example, to ensure continuous availability of the generated authorization configurations, a number of redundant copies of data store 270 are maintained at different locations and using different physical resources (e.g., primary data store 270-P, and redundant copies 270-1 through 270-N as illustrated in FIG. 3). In other embodiments, fraud rules generator 248 writes generated authorization configurations to data store 270, and a replication process periodically replicates and updates the redundant copies of data store 270 with new and/or changed authorization configurations. Furthermore, in some embodiments, the generated authorization configurations and/or redundant copies may be sharded and the shards distributed among different and/or remote physical resources. By distributing shards across multiple physical resource systems, such as server systems, a larger volumes of data and higher query loads can be handled, as each server can manage part of the workload independently, to process service requests authorizations and/or analytics queries, as discussed herein. In either embodiment, in the event a primary authorization configuration storage goes down or becomes inaccessible for other reasons, a redundant copy, redundant shard, etc. may be used in its place to ensure continuous availability of the authorization configurations.

Then, service request fraud detector 230, which acts as an interface of service request authorization system, such as an API endpoint, receives a connected client service request. The service request will include one or more identifiers (e.g., connected client identifier, platform client system identifier that can also be determined by fetcher 260 by a lookup based on the connected client identifier, hardware system identifiers, an IP address, account identifiers, tokens, cookies, etc.), and service request parameters (e.g., type of service request, time of request, origin location of request, amounts, ranges or values associated with the request, etc.). In embodiments, the identifier(s) are passed to authorization configuration fetcher 260.

Authorization configuration fetcher 260, upon receiving the identifiers, queries authorization configurations data store 270 for one or more authorization configurations associated with the identifiers. The obtained authorization configurations can include authorization configurations associated with the platform client identifier (e.g., authorization configurations defined by a platform client system) and/or authorization configurations associated with the connected client identifier (e.g., authorization configurations defined by a connected client). The configurations, as discussed herein, identify fraud detection processes to be used, define the thresholds used for the processes, define whether platform authorization configurations take precedence over, or are combined with, connected client authorization configurations, etc.

FIG. 3 is a block diagram of an embodiment of location based authorization configuration fetching performed by a service request authorization system. For example, authorization configuration fetcher 260-i may be an instance of an authorization configuration fetcher, and may be executed at a service system with physical resources located in geographic region i. Furthermore, connected client system 130-i is also located within geographic region i, so that service requests are transmitted to a local fraud detector 230-i.

In embodiments, authorization configuration fetcher 260-i selects a redundant data store copy (which in some embodiments is a data shard of a larger set of authorization configuration data shards), such as authorization configuration data store redundant copy 270-i, which is also located in geographic region i, and fetches authorization configurations from that redundant copy data store. In embodiments, by selecting the local redundant copy (e.g., the copy located in the same or closes geographic region), delay/latency introduced by the read, as well as the round trip of the network-based communications to fetch the authorization configurations, is minimized. This reduction of time to obtain the authorization configurations serves to reduce the time utilized to process a service request, which reduces resource usage consumed to process the service request authorization, and thus the service request itself. When considering the scale at which service requests are received and processed (e.g., millions or more a minute, hour, day, etc.), the savings in the aggregate of using the local authorization configurations fetching illustrated in FIG. 3, in terms of reduced latency and reduced overall service request processing time, are significant and result in a much more efficient fraud detection process performed by the service request authorization system 212.

Furthermore, in some embodiments, authorization configuration fetcher 260-i may further be configured to embed the authorization configurations read request of the data store 270-I as a secondary read. That is, since authorization configurations and/or shards of data store 270-P are distributed to redundant copies 270-1 through 270-N, the authorization configurations read request is executed as a secondary read. That is, the secondary read is a read of a non-primary data storage system, and instead is a read executed on a redundant copy of the authorization configurations and/or shard storing the relevant authorization configurations. By using a secondary read, more geographically close data stores may be queried for authorization configurations to reduce latency of reads of the data store. Furthermore, by using secondary reads, the distribution of those read requests to different redundant copies associated geographically with the locations of requesting connected clients enables the read requests to scale more efficiently (e.g., reduce bottlenecks in having all reads be serviced from a single data set). Therefore, enabling secondary reads for accessing authorization configurations can significantly save bandwidth based on the scale of service requests processed by the service request fraud detection systems discussed herein, while at the same time reducing overall latency of the authorization configuration fetching, and subsequent analysis.

Returning to FIG. 2, the fetched authorization configurations 232 are returned to service request fraud detector 230. The configurations, as discussed herein, define different modes of fraud detection (e.g., based on client system-level risk and service request-level risk), the parameters by which the fraud detection risk is determined (e.g., threshold values), what specific models are used, and whether platform client system configurations, connected client system configurations, or a combination thereof are used to configure one or more authorization processes. As discussed herein, for example, platform client system authorization configurations can be defined to exclude connected client configurations, which case connected client configurations would be discarded by fraud detector 230. As another example, platform client system authorization configurations can be defined to combine with connected client configurations, which causes fraud detector 230 analyze and combine detection results so that both authorization configurations have to be determined with respect to fraud detection.

The relevant authorization configurations, as well as service request parameters, are then passed to one or more of the risk model(s) 280 and 290. As discussed herein, the models detect risk associated with whether a connected client itself is fraudulent, as well as risk associated with whether a service request is fraudulent, by generation of a risk scores by one or more machine learning models, fraud models, heuristics analysis processes, etc. The scores are then provided to fraud detector which analyzes the scores based on the configured authorizations. For example, as discussed above, a rule or authorization may be configured to determine that a service request is fraudulent when connected_client_risk_score>X and service_request_risk_score>y.

A set of one or more configured authorization processes, based on the fetched authorization configurations and the analysis performed by models 280 and 290, are executed by service request fraud detector 230 to determine whether fraud has been detected. Action generator 275 receives the fraud detection results and either blocks the service request or allows the service request. The results are communicated by action generator 270 to a connected client system and/or a distributes service system (e.g., distributed service system 116). Furthermore, results of the fraud detection, including the configuration parameters are stored by action generator 275 in authorization results data store 246.

In embodiments, a rich source of authorization configuration efficacy information is retained by data store 246. Therefore, in embodiments, authorization configuration manager interface 240 is further responsible for generating an analytics user interface (e.g., a dashboard, web page, report sent via email, direct message, etc.). Authorization configuration manager interface 240 may receive an identifier of a platform client system, which is passed to analytics generator 244, as well as one or more query parameters, that are used to search and return authorization and service request analytics to a requesting platform client system.

Analytics generator 244 is responsible for accessing aggregated fraud detection outcomes and the authorization configurations/rules that generated those outcomes from data store 246. Because the volume of authorizations and outcomes is very high, in embodiments, analytics generator 244 may be a remote system that that periodically processes the authorization configurations and authorization results asynchronously with analytics requests, such as generating statistics or other analytics data associated with certain authorization configurations applied to service requests, combination of authorization configurations applied to service requests, etc. prior to receipt of the analytics requests. For example, the statistics and analytics data can include generating service request processing volumes, amounts, etc. for connected clients, how rules or rule combination impacted the processing volumes, demographics associated with service requests, trend analysis of rule and how the rules impacted service requests and/or authorizations, as well as other analytics that enable a connected client to see how service requests are being handled by the service request authorization system 212, and how certain configured rules are impacting those service requests. The statistical and analytics results generated by analytics generator 244 is stored in the authorization results data store 246.

Furthermore, in some embodiments, action generator 275 may receive one or more authorization updates after an authorization is performed. For example, a remote system (not shown) may reverse or alter a decision of the authorization system 212 subsequent to a service request, such as in response to the remote system detecting previously undetected fraud, issuing a refund for an exchange that occurred as a result of a service request, reversing an authorization decision, etc., and reports this update to the action generator 275. Action generator 275 stores the update with the associated service request data in data store 246. Analytics generator 244 then performs the periodic processing of the authorization results data store 246 to generate and update the generated statistics or other analytics data stored in authorization results data store 246.

Platform client systems are presented, via the generated interface, service request blocking and not blocking statistics aggregated by connected client system, across all their connected client systems, or for selected subsets of connected client systems. In some embodiments, additional factors such as later fraud reported (e.g., by a 3^{rd} party system), although no fraud was detected at the time of a service request, may be indicated to show ineffective authorization configurations and/or parameters (e.g., threshold values). This enables platform client systems insights as to individual connected client system, and across all their connected client system, enabling the platform client systems to write better authorization configurations/rules over time.

Furthermore, authorization configuration manager interface 240 may further include a test mode in which rule changes (e.g., altering existing configurations, thresholds, generating new configurations, etc.) are tested against historical data. Then, analytics generator 244 can determine fraud detection results of the rule changes compared with the existing authorization configurations rules to determine whether the changes increase or decrease efficacy of the fraud detection performed by service request authorization system 212.

In embodiments, each connected client system may also see the aggregated results of the fraud detection applied to its service requests. The fraud detection results provided to a connected client will provide analytics on their rules (e.g. block rates, false positive or false negative rates, etc.). However, in embodiments, the analytics provided by analytics generator 244 generates generic block statistics for platform client system authorization configurations/rules (e.g., platform configurations themselves and conditions are obscured). In embodiments, the actual configurations of the platform client system are obscured or genericized so that in the event a connected client system is fraudulent, they are not provided insight into fraud detection evasion. That is, a nefarious actor, knowing the configuration of authorization and fraud detection could adjust their behaviors to evade detection. Thus, in embodiments, only basic blocking statistics, such as blocking rates resulting from platform client system configurations, are provided to connected client systems, but not the configurations themselves.

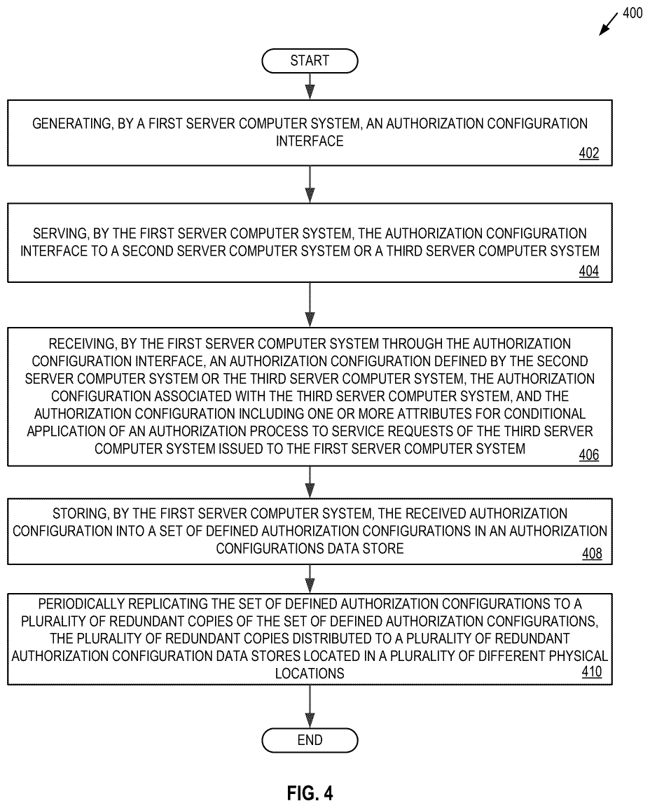

FIG. 4 is a block diagram of one embodiment of performing configuration of service request authorization. The method 400 is performed by processing logic that may comprise hardware (circuitry, dedicated logic, etc.), software (such as is run on a general purpose computer system or a dedicated machine), firmware, or a combination. In one embodiment, the method 400 is performed by a service request authorization system of a server computer (e.g., service request authorization system 112 or 212).

Referring to FIG. 4, processing logic begins by generating, by a first server computer system, an authorization configuration interface (processing block 402). The authorization interface is generated for an identified client system, such as a platform or connected client system identified based on one or more received identifiers, as discussed herein. Furthermore, the interface can be a dashboard user interface, web page, or other interface capable of being communicated over a network from the first server computer system to a receiving client system.

Processing logic serves, by the first server computer system, the authorization configuration interface to a second server computer system or a third server computer system (processing block 404). In embodiments, the second server computer system is a platform client system, and the third server computer system is a connected client system or a hosted connected client. Receipt of the interface by the second server computer system or the third server computer system causes the receiving system to render the authorization configuration interface on a display of the receiving system.

Processing then logic receives, by the first server computer system through the authorization configuration interface, an authorization configuration defined by the second server computer system or the third server computer system, the authorization configuration associated with the third server computer system, and the authorization configuration including one or more attributes for conditional application of an authorization process to service requests of the third server computer system issued to the first server computer system (processing block 406). In an embodiment, the second server computer system being associated with a platform client system enables the platform client system the ability to define fraud detections, what conditions the fraud detections are triggered, and for which connected client systems the fraud detections are triggered. Furthermore, in embodiments, the application of the authorization process may be conditional in that application depends on one or more attributes defined in the configuration parameters. For example, one or more identifiers may be used to define to which connected client systems an authorization configuration is applicable to, one or more attributes (e.g., connected client system age, a risk score, etc.) may define how an authorization is performed (e.g., connected client age in days<X, apply stricter rules or thresholds, connected client age in days>=X, apply reduced rules or thresholds), can define counter based attributes that configure how an authorization is performed (e.g., number of service request disputes received in last 30 days>Y, apply stricter rules or thresholds, and number of service request disputes received in last 30 days<=Y, apply easier rules or thresholds), connected client level attributes and service request level attributes can be combined into a single conditional statement for rule application (e.g., connected client age in days<X and number of service request disputes received in last 30 days>Y, apply stricter rules or thresholds, and otherwise apply more lax rules or thresholds). Thus, the configuration can define what authorizations to apply and how they are applied conditionally based on various counts, risk indicators, client system attributes, etc. This enables riskier connected client systems to be scrutinized more closely with configured authorization applications. Additionally, the connected client system level rules are new conditional features that enable platform clients control over the connected client for which the platform clients have liability based on their relationship to the first server computer system.

Processing logic stores, by the first server computer system, the received authorization configuration into a set of defined authorization configurations in an authorization configurations data store (processing block 408). Processing logic further periodically replicates the set of defined authorization configurations to a plurality of redundant copies of the set of defined authorization configurations, the plurality of redundant copies distributed to a plurality of redundant authorization configuration data stores located in a plurality of different physical locations (processing block 410). In some embodiments, a primary data store of authorization configurations can be sharded and distributed among different servers and/or physical resources. In this embodiment, the shards would be replicated and distributed to the redundant data stores. This distribution and redundancy of authorization configuration data stores and/or shards ensures availability of authorization configuration in the event a primary data store or copy is unavailable, and further enables more efficient rules fetching as discussed herein.

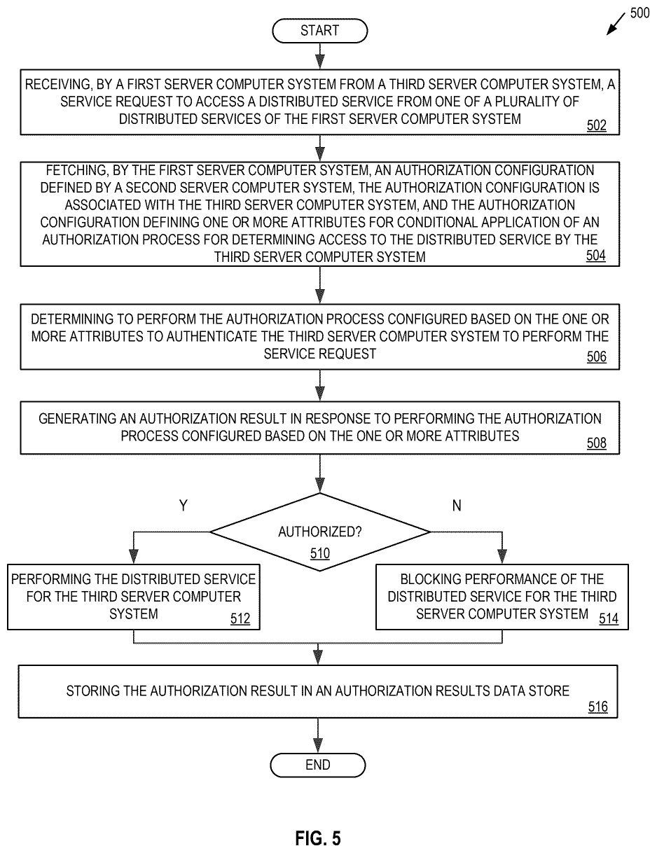

FIG. 5 is a flow diagram of one embodiment of a method for performing service request authorization. The method 500 is performed by processing logic that may comprise hardware (circuitry, dedicated logic, etc.), software (such as is run on a general purpose computer system or a dedicated machine), firmware, or a combination. In one embodiment, the method 500 is performed by a service request authorization system of a server computer (e.g., service request authorization system 112 or 212).

Referring to FIG. 5, processing logic begins by receiving, by a first server computer system from a third server computer system, a service request to access a distributed service from one of a plurality of distributed services of the first server computer system (processing block 502). The service request is a request to access one of a plurality of different distributed service (e.g., data access services, media control services, transaction authorization services, etc.), which are provided by the first server computer system. Furthermore, as discussed herein, the service request will pass one or more identifiers, such as client system identifiers, machine identifiers, IP addresses, account identifiers, etc., which enable processing logic to determine which client system, such as which connected client system or platform client system, originated the request.

Processing then logic fetches, by the first server computer system, an authorization configuration defined by a second server computer system, the authorization configuration is associated with the third server computer system, and the authorization configuration defining one or more attributes for conditional application of an authorization process for determining access to the distributed service by the third server computer system (processing block 504). In embodiments, the authorization configuration is fetched based on the identifier(s) received in the original request. Furthermore, the fetching may be location based and/or made as a secondary read request issued to a data store and/or shard copy that is stored by a system that is geographically proximate to the system making and/or processing the service request. In embodiment, these techniques reduce latency of configuration fetching to reduce bandwidth consumption by reducing the time consumed by processing the request (e.g., reducing rule fetching latency and reducing overall bandwidth consumption of rule fetching), and also therefore reduces service request processing latency. Due to the scale at which the processing logic operates, this results in significant latency reduction, reduction in bandwidth consumption, and improvements to the speed in which service requests can be approved and provided to requesting client systems.

Furthermore, the fetched authorization configuration defines one or more attributes for conditional application of an authorization process for determining access to the distributed service by the third server computer system. As discussed above, the attributes enable processing logic to determine whether to apply an authorization process to a requesting connected client system request and/or how the authorization is configured for execution by processing logic. Processing logic then determines to perform the authorization process configured based on the one or more attributes to authorize the third server computer system to perform the service request (processing block 506). For example, processing logic determines that attributes of the third server computer system, also referred to herein as a connected client system, and/or the service request, indicate application of one or more risk analyses configured based on the authorization configurations. For example, based on a configured connected client system age value that the current client system satisfies, a machine learning model analysis of service request features is to be carried out. Thus, as discussed herein, whether and how various heuristic, machine learning, and other fraud detection processes are carried out are conditionally based on the attributes of the requesting client system in relation to the authorization configurations.

Processing logic generates an authorization result in response to performing the authorization process configured based on the one or more attributes (processing block 508). For example, based on determination of connected client system attributes, machine learning model scoring, etc. in view of thresholds defined in an authorization configuration, processing logic is able to determine to perform or block performance of the requested service. When the authorization results is positive (processing block 510), processing logic performs the distributed service for the third server computer system (processing block 512). However, when the authorization results is negative (processing block 510), processing logic blocks performance of the distributed service for the third server computer system (processing block 514). Processing logic then stores the authorization result in an authorization results data store (processing block 516).

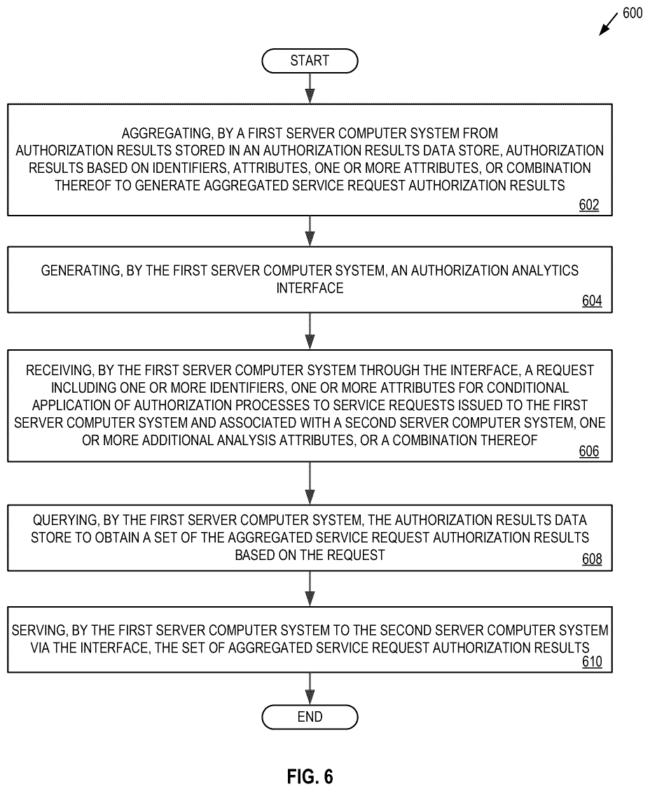

FIG. 6 is a flow diagram of another embodiment of a method for providing an analytics interface for analysis of configured authorization performance. The method 600 is performed by processing logic that may comprise hardware (circuitry, dedicated logic, etc.), software (such as is run on a general purpose computer system or a dedicated machine), firmware, or a combination. In one embodiment, the method 600 is performed by a service request authorization system of a server computer (e.g., service request authorization system 112 or 212).

Referring to FIG. 6, processing logic begins by aggregating, by a first server computer system from authorization results stored in an authorization results data store, authorization results based on identifiers, attributes, one or more attributes, or combination thereof to generate aggregated service request authorization results (processing block 602). As discussed above, authorization statistics and analytics, such as processing volume, amounts associated with processing volumes, fraud detection rates, etc. and applying and influence of rule configurations and/or rule combinations are computed against a corpus of available authorization results and associated authorization configurations (e.g., as stored in an authorization results data store 246). Furthermore, the aggregation performed by processing logic at block 602 is performed periodically and asynchronously with the subsequently received requests (e.g., processing block 606).

Processing logic then generates, by a first server computer system, an authorization analytics interface (processing block 604). Processing logic receives, by the first server computer system through the interface, a request that includes one or more identifiers, one or more attributes for conditional application of authorization processes to service requests issued to the first server computer system and associated with a second server computer system, one or more additional analysis attributes, or a combination thereof (processing block 606). Similar to the discussion above, the interface may a dashboard, web page, etc., and is generated based on one or more received identifiers that identify a requesting client system. In embodiments, both platform client systems and connected client systems may access the analytics analysis interfaces discussed herein. Furthermore, the requests to access request authorization results can include specification of the systems for which results are requested (e.g., an individually identified system, systems located in a geographic region, all systems, etc.), timeframes of requested results (e.g., last hour, last day, a date range such as between X and Y, etc.), attributes of conditional application of authorizations (e.g., client system age value or range, client system risk scoring metric(s), etc.), as well as other data values that can define individual or groups of client systems for analysis.

Processing logic then queries, by the first server computer system, the authorization results data store to obtain a set of the aggregated service request authorization results based on the request (processing block 608). In embodiments, the query is a database or data access query using the request parameters to access analytics results generated at processing block 602.

When a platform client system (e.g., the second server computer system) accesses their request authorization results, they may obtain aggregated results across all connected clients for which they are associated, one or more sets of connected clients formed based on the received identifiers or attributes, and individual connected clients. Furthermore, the platform client systems may access full analysis results including attributes and application parameters used to determine which risk models are applied, the conditions for their selection, and their actual application in order to judge effectiveness on a global connected client level, on sub levels (e.g. based on client attributes such as age, request volume, number of disputes, etc.). However, when a connected client system seeks access to fraud detection analysis applied to service request authorization results, the connected client system will see their results. In particular, connected client system rule configurations may be aggregated based on specific configuration conditions, thresholds, etc. However, a connected client system will only be provided with a basic summary of platform client system authorization configuration application results (e.g., X service requests blocked from platform client system configurations over last Y day). The high level summary of service request authorization results of platform authorization configurations is made to prevent unintentionally releasing sensitive fraud detection information to a potential nefarious actor. For example, if a connected client is established to perpetrate fraud, an analytics analysis that identifies thresholds and conditions used to apply and analyze service requests can be used by the nefarious connected client to evade fraud detection.

Processing logic then serves, by the first server computer system to the second server computer system via the interface, the set of aggregated service request authorization results (processing block 610).

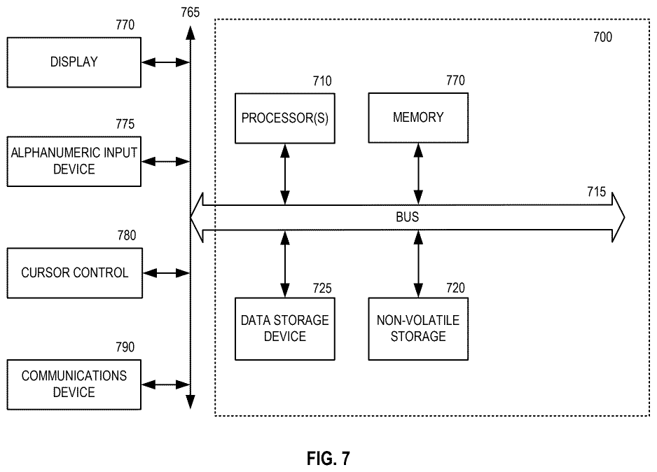

FIG. 7 is one embodiment of a computer system that may be used to support the systems and operations discussed herein. For example, the computer system illustrated in FIG. 7 may be used by a server computer system, a platform client system, a connected client system, etc. It will be apparent to those of ordinary skill in the art, however that other alternative systems of various system architectures may also be used.

The data processing system illustrated in FIG. 7 includes a bus or other internal communication means 715 for communicating information, and a processor 710 coupled to the bus 715 for processing information. The system further comprises a random access memory (RAM) or other volatile storage device 750 (referred to as memory), coupled to bus 715 for storing information and instructions to be executed by processor 710. Main memory 750 also may be used for storing temporary variables or other intermediate information during execution of instructions by processor 710. The system also comprises a read only memory (ROM) and/or static storage device 720 coupled to bus 715 for storing static information and instructions for processor 710, and a data storage device 725 such as a magnetic disk or optical disk and its corresponding disk drive. Data storage device 725 is coupled to bus 715 for storing information and instructions.

The system may further be coupled to a display device 770, such as a light emitting diode (LED) display or a liquid crystal display (LCD) coupled to bus 715 through bus 765 for displaying information to a computer user. An alphanumeric input device 765, including alphanumeric and other keys, may also be coupled to bus 715 through bus 765 for communicating information and command selections to processor 710. An additional user input device is cursor control device 780, such as a touchpad, mouse, a trackball, stylus, or cursor direction keys coupled to bus 715 through bus 765 for communicating direction information and command selections to processor 710, and for controlling cursor movement on display device 770.

Another device, which may optionally be coupled to computer system 700, is a communication device 790 for accessing other nodes of a distributed system via a network. The communication device 790 may include any of a number of commercially available networking peripheral devices such as those used for coupling to an Ethernet, token ring, Internet, or wide area network. The communication device 790 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 750, mass storage device 725, or other storage medium locally or remotely accessible to processor 710.

It will be apparent to those of ordinary skill in the art that the system, method, and process described herein can be implemented as software stored in main memory 750 or read only memory 720 and executed by processor 710. This control logic or software may also be resident on an article of manufacture comprising a computer readable medium having computer readable program code embodied therein and being readable by the mass storage device 725 and for causing the processor 710 to operate in accordance with the methods and teachings herein.

The embodiments discussed herein may also be embodied in a handheld or portable device containing a subset of the computer hardware components described above. For example, the handheld device may be configured to contain only the bus 715, the processor 710, and memory 750 and/or 725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 710, a data storage device 725, a bus 715, and memory 750, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

We claim:

1. A method for authorization of a distributed service request by a first server computer system, comprising:
receiving, by the first server computer system from a third server computer system, a service request to access a distributed service from one of a plurality of distributed services of the first server computer system;
fetching, by the first server computer system, an authorization configuration defined by a second server computer system, the authorization configuration is associated with the third server computer system, and the authorization configuration defining one or more attributes for conditional application of an authorization process for determining access to the distributed service by the third server computer system;
determining, by the first server computer system, to perform the authorization process configured based on the one or more attributes to authorize the third server computer system to perform the service request; and
generating, by the first server computer system, an authorization result in response to performing the authorization process configured based on the one or more attributes.

2. The method of claim 1, further comprising:
in response to the authorization results being a positive authorization, performing the distributed service for the third server computer system;
in response to the authorization results being a failed authorization, blocking performance of the distributed service for the third server computer system; and
storing the authorization result and the one or more attributes in a record associated with the service request in a data store.

3. The method of claim 2, further comprising:
receiving, by the first server computer system from a remote server computer system, data indicating a reversal of the authorization result; and
storing the reversal of the authorization result in the record.

4. The method of claim 2, further comprising:
aggregating, by the first server computer system from authorization results stored in the data store, a plurality of authorization results based on one or more identifiers, one or more attributes for conditional application of authorization processes to service requests issued to the first server computer system and associated with a second server computer system, one or more additional analysis attributes, or a combination thereof to generate aggregated service request authorization results;
receiving, by the first server computer system from the second server computer system, a request that comprises one or more identifiers, one or more attributes for conditional application of authorization processes to service requests issued to the first server computer system and associated with a second server computer system, one or more additional analysis attributes, or a combination thereof;
querying, by the first server computer system, the data store to obtain a set of the aggregated service request authorization results based on the request; and
serving, by the first server computer system to the second server computer system, the set of aggregated service request authorization results.

5. The method of claim 4, wherein the one or more identifiers comprise an identifier associated with the third server computer system, and the one or more attributes comprise an authorization process configuration applied to an authorization process performed against the requests of the third server computer system, and the aggregated service request authorization results comprise data indicative of results of the authorization process against performed for the third server computer system using the authorization process configuration.

6. The method of claim 1, further comprising:
receiving, by the first server computer system, the authorization configuration defined by the second server computer system, the authorization configuration associated with the third server computer system, and the authorization configuration including the one or more attributes for conditional application of the authorization process to the service request; and
storing, by the first server computer system, the received authorization configuration into a set of authorization configurations in a data store.

7. The method of claim 6, further comprising:
periodically replicating the set of authorization configurations to a plurality of redundant copies of the set of defined authorization configurations, the plurality of redundant copies distributed to a plurality of redundant data stores located in a plurality of different physical locations.

8. The method of claim 7, wherein the fetching further comprises:
determining, by the first server computer system, a first physical location where the third server computer system is located;
selecting, by the first server computer system, a copy of the set of defined authorization configurations that is stored in a data store located at a second physical location within a threshold distance of the first physical location; and
fetching, by the first server computer system, the authorization configuration from the selected copy of the set of defined authorization configurations.

9. The method of claim 1, wherein the fetching further comprises:
performing, by the first server computer system, a read operation to access the authorization configuration from a record stored in a data store, the read issued in parallel with at least one additional read operation issued by the first server computer system to a computer system that maintains the data store.

10. The method of claim 1, wherein the second server computer system establishes an account for the third server computer system with the first server computer system, and the account enables access to the distributed service of the first server computer system.

11. A non-transitory computer readable storage medium having instructions stored thereon, which when executed by a processing system of a first server computer system, cause the first server computer system to perform operations for authorization of a distributed service request by the first server computer system, comprising:
receiving, by the first server computer system from a third server computer system, a service request to access a distributed service from one of a plurality of distributed services of the first server computer system;
fetching, by the first server computer system, an authorization configuration defined by a second server computer system, the authorization configuration is associated with the third server computer system, and the authorization configuration defining one or more attributes for conditional application of an authorization process for determining access to the distributed service by the third server computer system;
determining to perform the authorization process configured based on the one or more attributes to authorize the third server computer system to perform the service request; and
generating an authorization result in response to performing the authorization process configured based on the one or more attributes.

12. The non-transitory computer readable storage medium of claim 11, the operations further comprising:
in response to the authorization results being a positive authorization, performing the distributed service for the third server computer system;
in response to the authorization results being a failed authorization, blocking performance of the distributed service for the third server computer system; and
storing the authorization result and the one or more attributes in a record associated with the service request in a data store.

13. The non-transitory computer readable storage medium of claim 12, the operations further comprising:
aggregating, by the first server computer system from authorization results stored in the data store, a plurality of authorization results based on one or more identifiers, one or more attributes for conditional application of authorization processes to service requests issued to the first server computer system and associated with a second server computer system, one or more additional analysis attributes, or a combination thereof to generate aggregated service request authorization results;
receiving, by the first server computer system from the second server computer system, a request that comprises one or more identifiers, one or more attributes for conditional application of authorization processes to service requests issued to the first server computer system and associated with a second server computer system, one or more additional analysis attributes, or a combination thereof;
querying, by the first server computer system, the data store to obtain a set of the aggregated service request authorization results based on the request; and
serving, by the first server computer system to the second server computer system, the set of aggregated service request authorization results.

14. The non-transitory computer readable storage medium of claim 11, the operations further comprising:
receiving, by the first server computer system, the authorization configuration defined by the second server computer system, the authorization configuration associated with the third server computer system, and the authorization configuration including the one or more attributes for conditional application of the authorization process to the service request; and
storing, by the first server computer system, the received authorization configuration into a set of authorization configurations in a data store.

15. The non-transitory computer readable storage medium of claim 11, wherein the operations for fetching further comprise operations for:
performing, by the first server computer system, a read operation to access the authorization configuration from a record stored in a data store, the read issued in parallel with at least one additional read operation issued by the first server computer system to a computer system that maintains the data store.

16. A first server computer system, comprising:
a memory storing instructions; and
a processing system, coupled with the memory, configured to execute the instructions causing the first server computer system to perform operations, comprising:
receiving, by the first server computer system from a third server computer system, a service request to access a distributed service from one of a plurality of distributed services of the first server computer system,
fetching, by the first server computer system, an authorization configuration defined by a second server computer system, the authorization configuration is associated with the third server computer system, and the authorization configuration defining one or more attributes for conditional application of an authorization process for determining access to the distributed service by the third server computer system,
determining to perform the authorization process configured based on the one or more attributes to authorize the third server computer system to perform the service request, and
generating an authorization result in response to performing the authorization process configured based on the one or more attributes.

17. The first server computer system of claim 16, wherein the processing system executes the instructions causing the first server computer system to perform further operations, comprising:
in response to the authorization results being a positive authorization, performing the distributed service for the third server computer system;
in response to the authorization results being a failed authorization, blocking performance of the distributed service for the third server computer system; and
storing the authorization result and the one or more attributes in a record associated with the service request in a data store.

18. The first server computer system of claim 17, wherein the processing system executes the instructions causing the first server computer system to perform further operations, comprising:
aggregating, by the first server computer system from authorization results stored in the data store, a plurality of authorization results based on one or more identifiers, one or more attributes for conditional application of authorization processes to service requests issued to the first server computer system and associated with a second server computer system, one or more additional analysis attributes, or a combination thereof to generate aggregated service request authorization results;
receiving, by the first server computer system from the second server computer system, a request that comprises one or more identifiers, one or more attributes for conditional application of authorization processes to service requests issued to the first server computer system and associated with a second server computer system, one or more additional analysis attributes, or a combination thereof;
querying, by the first server computer system, the data store to obtain a set of the aggregated service request authorization results based on the request; and
serving, by the first server computer system to the second server computer system, the set of aggregated service request authorization results.

19. The first server computer system of claim 16, wherein the processing system executes the instructions causing the first server computer system to perform further operations, comprising:
receiving, by the first server computer system, the authorization configuration defined by the second server computer system, the authorization configuration associated with the third server computer system, and the authorization configuration including the one or more attributes for conditional application of the authorization process to the service request; and
storing, by the first server computer system, the received authorization configuration into a set of authorization configurations in a data store.

20. The first server computer system of claim 16, wherein the processing system executes the instructions causing the first server computer system to perform further operations, comprising:
performing, by the first server computer system, a read operation to access the authorization configuration from a record stored in a data store, the read issued in parallel with at least one additional read operation issued by the first server computer system to a computer system that maintains the data store.
